(19) United States
(12) Patent Application Publication
(10) Pub. No.: US 2020/0394169 A1
(43) Pub. Date: Dec. 17, 2020

(54) ON-DEMAND, USER-CONFIGURABLE TYPE-LENGTH-VALUE (TLV) DEVICE AND METHOD

(71) Applicant: HEWLETT PACKARD ENTERPRISE DEVELOPMENT LP, Houston, TX (US)

(72) Inventors: Abhay Bhaskar, Bangalore (IN); Krishna Mohan Elluru, Bangalore (IN); Mahammadnaeem Karimbhai Memon, Bangalore (IN)

(21) Appl. No.: 16/439,879

(22) Filed: Jun. 13, 2019

(51) Int. Cl. G06F 16/22; G06F 16/23

(52) U.S. Cl. CPC G06F 16/2291; G06F 16/2379

(57) ABSTRACT

Methods and systems are provided for creating and using custom Type-Length-Value (TLV) elements. For example, a method includes receiving an information from a user, the information including a plurality of commands that together define both a type and a structure of a custom TLV, parsing the received information to create a custom TLV configuration database entry using the received plurality of commands, and writing the TLV configuration database entry into a TLV configuration database accessible by a message parsing device.

### BACKGROUND

In modern communications, messages between different devices may be transmitted according to a protocol such that a single message may contain a number of different elements known as Type Length Values (TLVs). A TLV is a particular type of encoding scheme having three fields including a “Type” field, a “Length” field, and a “Value” field. The type field contains a particular number that refers to a specific category of information according to any one of a number of vendor-neutral or vendor-specific registries. The length field designates the size of information within a TLV. The value field contains information of interest of a size expressed by the length field.

### BRIEF DESCRIPTION OF THE DRAWINGS

Various examples of this disclosure that are proposed as examples will be described in detail with reference to the following figures, wherein like numerals reference like elements, and wherein:

FIG. 1 depicts an example table describing type attributes used for custom TLVs.

FIG. 2 depicts an example table describing field attributes for custom TLVs.

FIG. 3 depicts a communication system that uses an improved TLV control approach whereby both custom and standard TLVs are supported.

FIG. 4 is a block diagram of an example custom TLV control system usable to quickly create and deploy custom TLVs.

FIGS. 5A-5C together provide an example computer-based script usable by a processing system to quickly create and deploy a custom TLV.

FIG. 6 depicts a number of example database entries for custom TLVs created using the disclosed methods and systems.

FIG. 7 is a block diagram of an example TLV configuration management system usable to quickly create and deploy custom TLVs.

FIG. 8 is a flowchart of a method usable to quickly create and deploy custom TLVs.

### DETAILED DESCRIPTION

The methods and systems disclosed below may be described generally, as well as described in terms of specific examples. For instances where references are made to detailed examples, it is noted that any of the underlying principles described are not to be limited to a single example but may be expanded for use with any of the other methods and systems described herein as will be understood by one of ordinary skill in the art unless otherwise specifically stated.

For the purposes of this disclosure, the following definitions apply.

The term “process” refers to a set of instructions that may be encoded so as to be implemented on one or more computer-based machines.

The term “message” refers to some form of formatted information that is transmitted by a first communication device (or system) and received by a second communication device (or system).

The term “TLV” (as discussed above) refers to a particular type of encoding scheme having three fields including a “Type” field, a “Length” field, and a “Value” field. When embedded in a message, any number of individual TLV elements can be placed in any order within the body of the message.

The term “standard” as used herein refers to any rule or set of rules used to establish one or more conforming properties of a TLV and that are obligatory to TLV recognition. For example, a “standard” TLV is typically obliged to contains a type field that is a pure binary number of a fixed size. Similarly, it is standard for a length field to be an eight-bit unsigned integer. A failure to conform with a set of TLV standards will typically result in an inoperable TLV that will not be recognized and parsed by devices designed to process TLVs.

The term “custom” as used herein refers to any TLV that is designed to satisfy some utility not met by any known/registered TLV. For example, a number of new, custom TLVs may be deemed appropriate to address a notification process designed to defend against a new form of illicit computer intrusion in a specialized communication system, such as a VLAN (Virtual Local Area Network).

The term “script” as used herein is to be broadly defined as any sequence of information, e.g., commands and/or parameters, provided by a user capable of defining a custom TLV. For example, it is to be appreciated that a “script” may be provided as a stand-alone file/document, or as a part of a larger document. For instance, an individual “script” may take the form as a portion of a document that includes multiple TLV-related scripts or as a document that contains other commands/information not directed to TLVs. Further, it is also to be appreciated that a “script” may take the form of information/commands provided using any number of more interactive approaches, such as information/commands entered by a user via a Command Line Interface (CLI) or entered in appropriately labeled fields provided by a Graphic User Interface (GUI).

The term “structure” as used with respect to TLVs refers to the arrangement, combination and size of data fields/attributes within a TLV. For example, the length of a TLV and the length of a specific portion of a TLV are aspects of a TLV's structure. Similarly, “structure” may refer to the number of different fields i attributes within the TLV, and the relative arrangement of the fields/attributes. “Structure” also refers to the type of data (e.g., binary, decimal, string, MAC (Media Access Control), etc.) within a TLV. That is, while a particular numeric value may not be an issue of structure, whether the particular number is represented by an alphanumeric string, represented by a decimal formatted number or represented by a binary formatted number is an issue of structure.

The term “registry” refers to any formal or informal list of TLVs that are supported by a particular vendor or protocol. Similarly, a “registered” TLV refers to a TLV that is supported by a particular vendor or protocol. For example, a TLV may be considered “registered” if supported by a single vendor. Similarly, a TLV may be considered “registered” if it is supported by any protocol established by industry agreement or by a standards-making body.

Thus, TLVs may be considered as either vendor-specific or vendor-neutral.

Vendor-specific TLVs generally refer to TLVs established to support a specific vendor's product line. Most control plane protocols allow individual vendors to define TLVs according to their own TLV-conforming registries to enable effective communication between compatible devices. However, the idea of “vendor-specific” may be extended to any single manufacturer, group of manufacturers, or similar entities that agree to support a particular product line. An example of a vendor-specific protocol is Hewlett-Packard Enterprises' Aruba operating system (ArubaOS)™, which may be used to define vendor-specific TLVs to detect device types and to communicate the existence of rogue access points (APs) on a network.

Vendor-neutral TLVs refer to TLVs established to support some form of industry-standard protocol. An example of a vendor-neutral protocol that uses TLV technology is the Link Layer Discovery Protocol (LLDP), which is a vendor-neutral Data Link Layer (DLL) protocol used by networked devices to advertise their identity, capabilities, and neighbors on Local Area Networks (LANs).

Most network vendors support vendor-neutral TLVs as part of general protocol compliance but, due to the expense, the same vendors may be reluctant to add even limited support for vendor-specific issues. The problem may be complicated when vendors are asked to support heterogeneous networks that use equipment from multiple vendors.

Supporting a new TLV (vendor-neutral or vendor-defined) typically involves a firmware upgrade to any device intended to use the new TLV. Such firmware upgrades, in turn, can involve a lengthy delay. For example, when a particular vendor needs to add support for LLDP-based TLVs the vendor will likely need to invest considerable time and resources in the firmware code that supports the appropriate LLDP module, which directly affected the time-to-market for the appropriate firmware upgrade release.

To address this time-to-market delay, the disclosed methods and systems use an approach where a user (e.g., network/system administrator) can directly configure a switch (or other communication device) to detect new, custom TLVs using a predefined software-based script that does not require direct vendor support. The disclosed methods and systems also allow the user to define those specific actions a device should take upon receipt of such new TLVs. By allowing system/network administrators to create custom TLVs, any delay for waiting for firmware upgrades may be mitigated. Such an approach provides an on-demand capability for customers to enable specific utility independent of the vendors that supply their equipment by creating their own TLV libraries.

These TLV libraries, which can take the form of any number of database structures: (1) identify the various components of custom TLVs, (2) define the actions to execute on identifying custom TLVs, and (3) define other properties for filtering the custom TLVs, such as the “max occurrences” of a TLV, “on repeat action” for a TLV, etc. Such a library thus eliminates the need for adding detection logic for any new TLV that would otherwise need to be directly supported by vendor-supplied firmware.

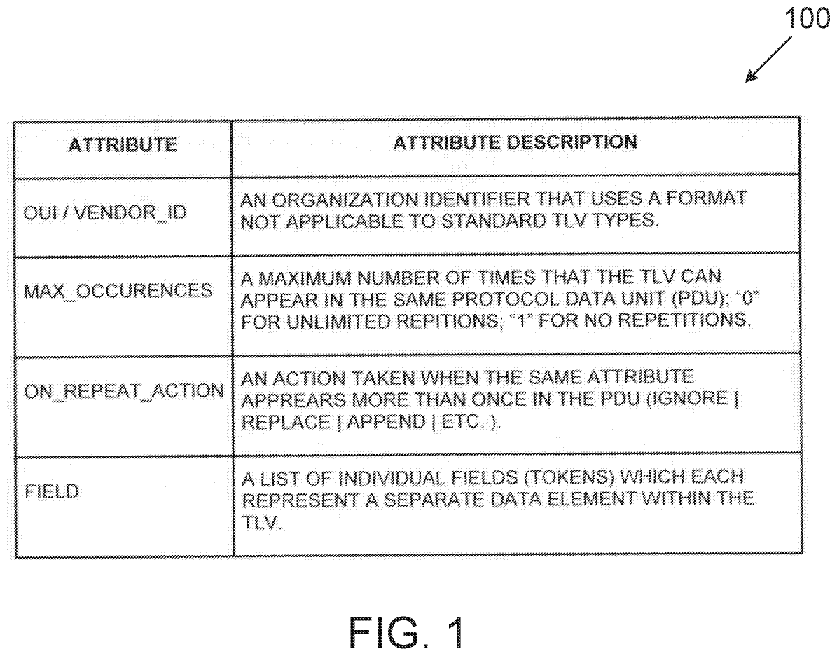

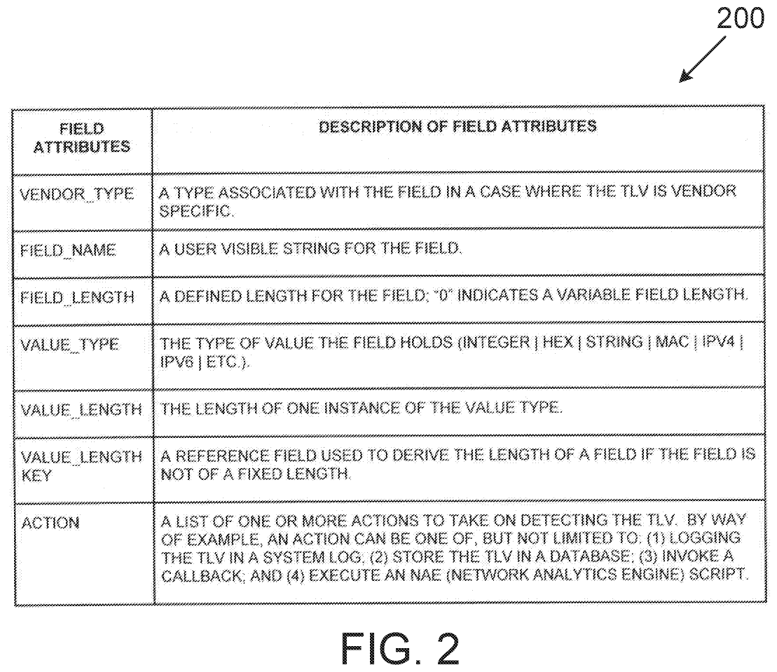

FIGS. 1 and 2 are provided as examples of database attributes suitable for custom TLVs. As shown in FIG. 1 an example table 100 is depicted describing “type” attributes used for example custom TLVs. The TLV type attributes for the example of FIG. include an OUI/VENDOR_ID attribute, a MAX_OCURANCES attribute, an ON_REPEAT_ACTION attribute, and a FIELD(S) attribute.

The OUI (organizationally unique identifier)/VENDOR_ID attribute in standard TLVs is typically a 24-bit number that uniquely identifies an organization, e.g., a vendor, manufacturer, or other organization. However, as is further discussed below for the example of the present disclosure, the OUI/VENDOR_ID attribute can optionally use a non-standard format, e.g., an alphanumeric string, that will not be processed by devices/systems that are not appropriately modified to recognize such non-standard OUI/VENDOR_ID attributes.

The MAX_OCURANCES attribute defines the maximum number of times that the custom TLV can appear in the same Protocol Data Unit (PDU), and the ON_REPEAT_ACTION attribute defines an action to take when the same attribute of a custom TLV appears more than once in a PDU.

Finally, the FIELD attribute defines a list of individual fields (tokens) which each represent a separate data element within the custom TLV.

Turning to FIG. 2, an example table 200 describing field attributes for custom TLVs is provided. As shown in FIG. 2, example field attributes include VENDOR_TYPE (i.e., a type associated with the field when the field is vendor specific), a FIELD_NAME (i.e., a user-visible string for the field), a FIELD_LENGTH (i.e., a defined length of the field), a VALUE_TYPE (i.e., the data type for the field value), a VALUE_LENGTH_KEY (i.e., a reference field when the length of a field is not fixed), and ACTION (i.e., a list of one or more actions a device/system takes upon detecting the custom TLV).

As with the OUI/VENDOR_ID attribute of FIG. 1, in various examples any other attribute described in either FIG. 1 or FIG. 2 may take a non-standard form. However, it is to be appreciated that any non-standard portion of a custom TLV, such as the OUI/VENDOR_ID attribute discussed above, may be replaced with a standard designation when a custom TLV is formally registered/supported by a vendor.

As is demonstrated below, the disclosed methods and systems provide a number of distinct advantages. For instance, the disclosed methods and systems provide a unique platform where TLVs represent a user-configurable attribute that allows users to provide new and useful functionality for networking platforms that, without the disclosed methods and systems, would not allow for customization. That is, the present methods and systems provide an approach that de-couples the data and control planes so as to enable direct user-control of a network's data plane thus making network administration more flexible. Further, the disclosed methods and systems provide for a wide variety of user-friendly and intuitive tools to enable this customization.

Accordingly, the following advantages are provided. First, a user does not have to depend on a switch vendor to support a new TLV, which is a substantial advantage for small network providers that present only a small percentage of a vendor's business.

Second, users can use the disclosed methods and systems to design TLVs across different (otherwise incompatible) switches made by different vendors.

Third, the present methods and systems minimize “code churn.” By way of example, a system “bug” fix may be analyzed and resolved in a matter of hours by a user versus a matter of months by a vendor. Still further, a bug-related software performance regression (i.e., a situation where the software still functions correctly, but performs slowly and/or uses more memory than before due to a system patch caused by bug fixes included in a system firmware patch) may also be resolved in a matter of hours by a user versus a matter of months by a vendor.

As is discussed below, in order to make the disclosed methods and systems more user-friendly, human-readable data serialization languages, such as YAML or JSON, may be used to create the above-described TLV libraries according to a user-friendly grammar. However, any data serialization language capable of converting structured data to a format that allows sharing or storage of the data in a form that allows recovery of its original structure may be equally advantageous, while other languages (although usable) may be less advantageous.

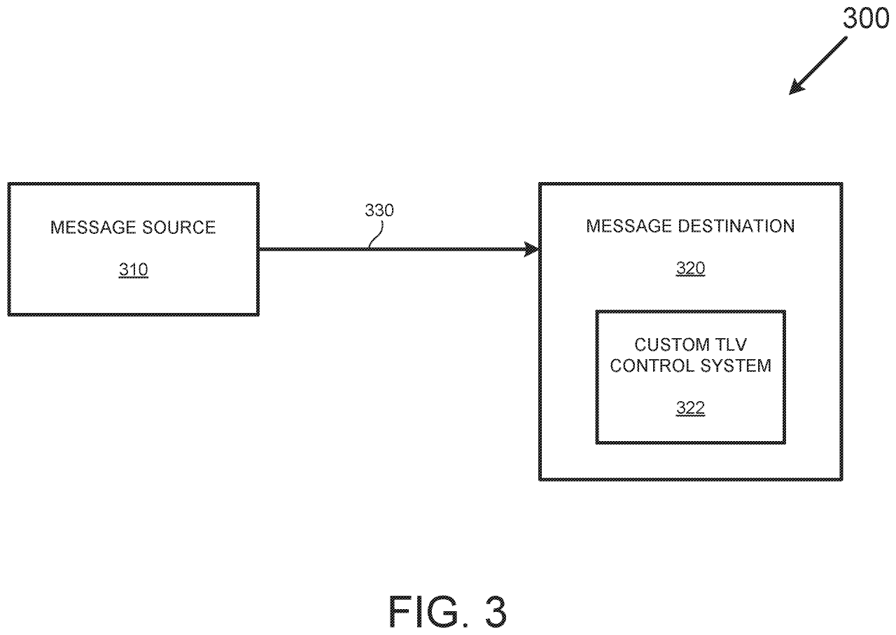

Returning now to the drawings, FIG. 3 depicts a communication system 300 that uses an improved TLV control approach whereby both custom and standard TLVs are supported. As shown in FIG. 3, the communication system 300 includes a message source 310 and a message destination 320 with the message destination 320 including a custom TLV control system 322. The message source 310 is communicatively coupled to the message destination 320 via a communication conduit 330.

The message source 310 and message destination 320 of the example of FIG. 3 may be any number of different communication systems configured to communication according to any number of protocols. For example, the message source 310 and message destination 320 may be cellular systems, ethernet-based systems, wireless network-based systems, and so on. Similarly, the communication conduit 330 may include any physical medium and combination of devices capable of communicatively coupling (directly or indirectly) a number of communication systems.

In operation, the message source 310 sends a number of messages containing TLV elements to the message destination 320 via the communication conduit 330.

In response, the message destination 330 receives the messages containing the TLV elements, recognizes the individual TLV elements, parses the individual TLV elements, and performs one or more actions (e.g., store a value within a TLV in a database) based upon one or more commands inherent to, or expressly encoded within, the individual TLVs.

However, in addition to recognizing, parsing, and processing known TLV, the custom TLV control system 322 allows the message destination 320 to recognize and parse custom TLVs that are not of a standard format and/or not registered. While it may be inferred from FIG. 3 that the custom TLV control system 322 is wholly a component of the message destination 320, in various examples the custom TLV control system 322 may contain any number of components that are external to a particular communication system or piece of equipment.

While explained below in greater detail, the concept used by the custom TLV control system 322 involves receiving a script that includes a plurality of commands that together define both the type of the custom TLV and the structure of the custom TLV, then processing the received script to create a custom TLV configuration database entry. Once the custom TLV database entry is created it may be stored in a TLV configuration database accessible by a message parsing device, which in turn can use the custom TLV database entry to recognize, parse, and otherwise process custom TLVs.

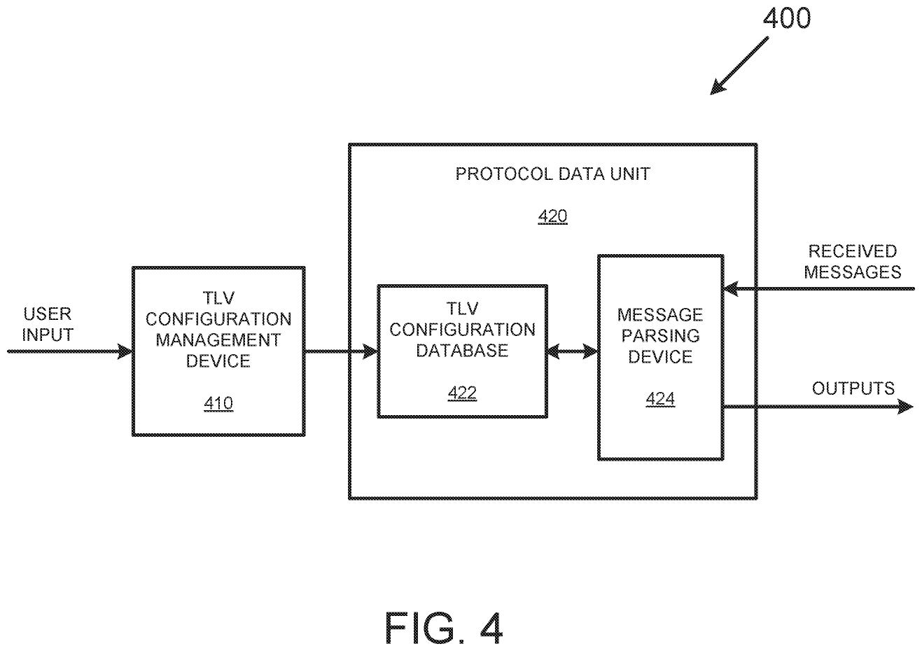

FIG. 4 is a block diagram of an example custom TLV control system 400 usable to quickly create and deploy custom TLVs. As shown in FIG. 4, the custom TLV control system 400 includes a TLV configuration management device 410 communicatively coupled to a Protocol Data Unit (PDU) 220 that includes a TLV configuration database 422 communicatively coupled to a message parsing device 424.

The TLV configuration management device 410 of the example of FIG. 4 can be a stand-alone computer system, the TLV configuration database 422 can be any form of known or later-developed storage devices, such as a magnetic disk or computer-memory, and the message parsing device 424 may be any combination of programmable device, dedicated logic and electronic circuitry.

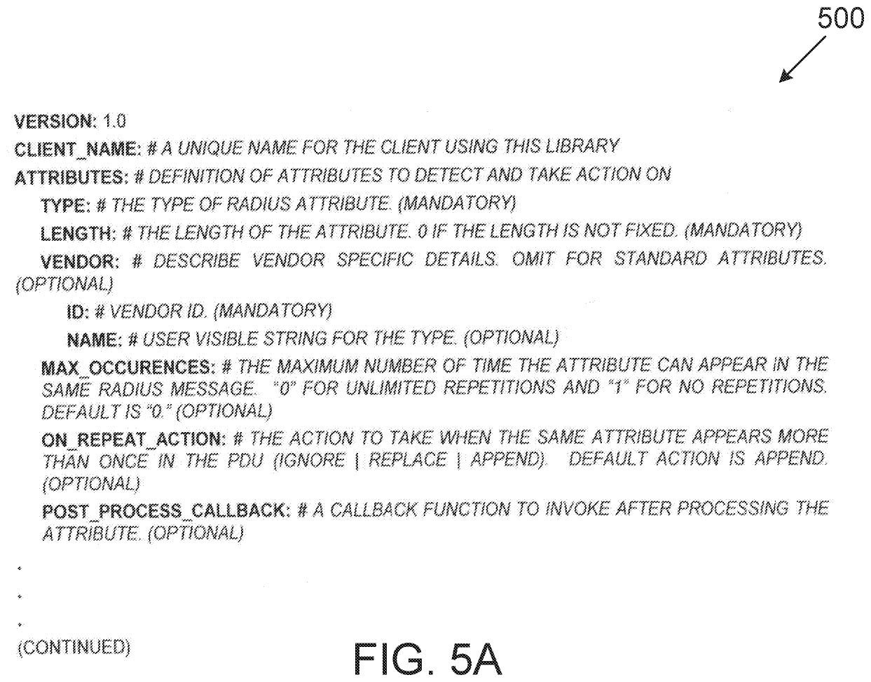

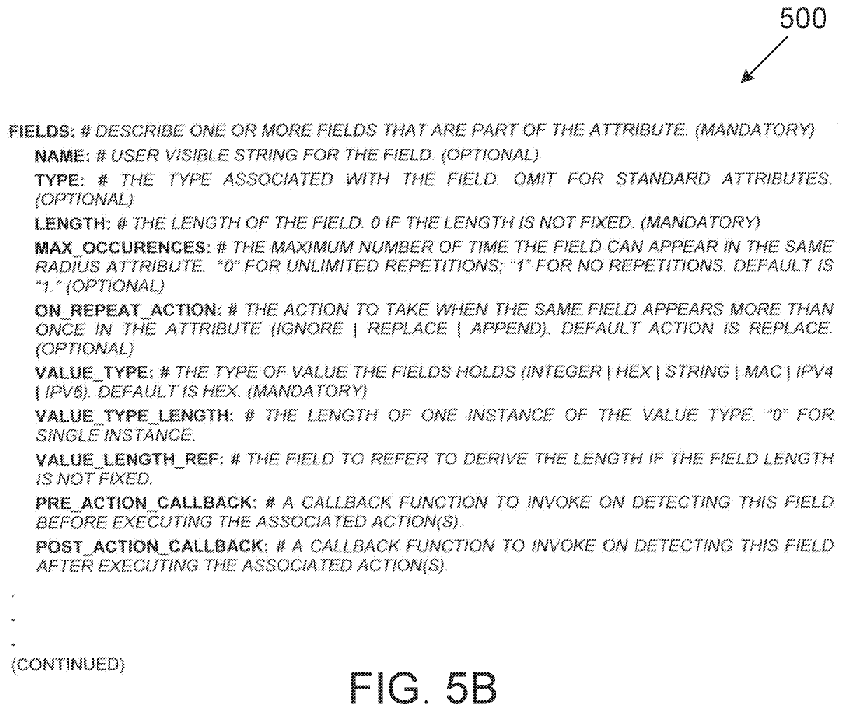

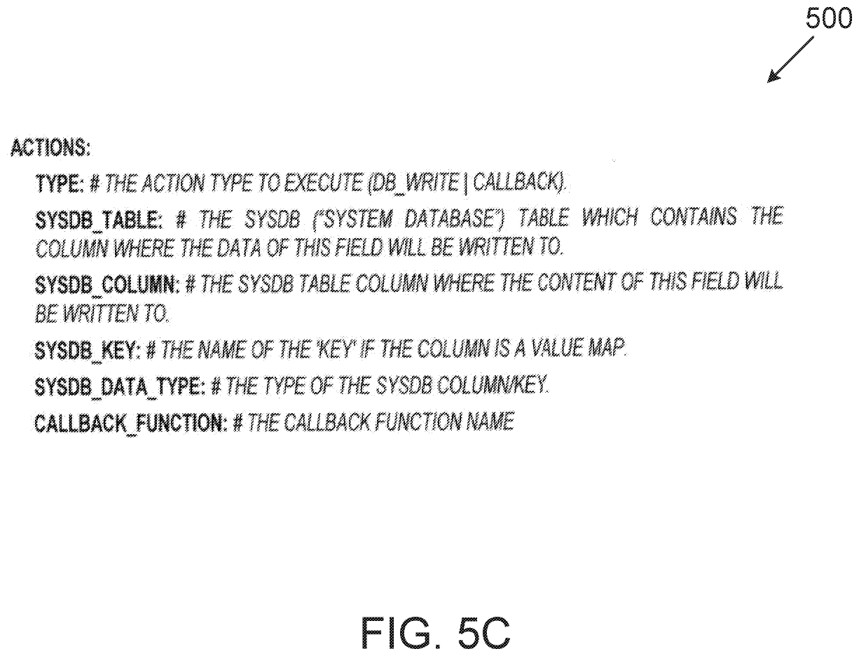

In operation the TLV configuration management device 410 allows a user (e.g., a network/system administrator) to “enter” a script (which encompasses entering data into and/or modifying a pre-made script template). FIGS. 5A-5C provide an example script 500 (script template) usable by the example TLV configuration management device 410 of FIG. 4 to quickly create a custom TLV. As shown in FIGS. 5A-5C, the script 500 includes a plurality of commands usable by a processing system to define various attributes and desired actions for a custom TLV.

For example, as shown in FIG. 5A, the script 500 includes commands that allow a user to: (1) define a unique non-standard name for an organization using the custom TLV; (2) provide definitions for one or more attributes of the custom TLV that a message parsing device is to detect and perform desired action(s) for; and (3) provide a list of one or more fields that are part of each of the one or more attributes. Similarly, FIG. 5C discloses a number of commands that define a list of desired actions that enable a message parsing device to perform the desired actions for any TLV element that conforms with the custom TLV. While the example script 500 of FIGS. 5A-5C is not meant to be inclusive of all possible commands, the example script 500 does provide a usable template as to how a TLV script may be entered by a user and received by the TLV configuration management device 410 or any other processing device/system.

A particular advantage of the example script 500 of FIGS. 5A-50 is the use of default predefined settings that will be entered into a custom TLV configuration database entry in the absence of a command that defines a particular attribute. For example, in FIG. 5A it is shown that the MAX_OCCURANCES and ON_REPEAT_ACTION commands provide defaults when not addressed by a specific script command to the contrary. Accordingly, a usable custom TLV configuration database entry may be formed without expressly addressing every aspect of a custom TLV.

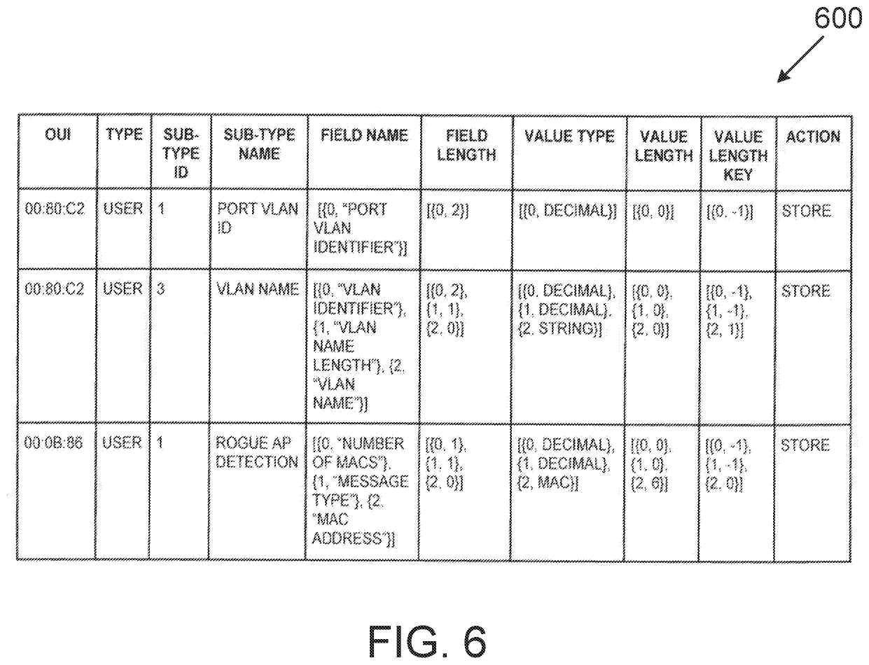

Returning to FIG. 4, once the script is received by the TLV configuration management device 410, the TLV configuration management device 410 can process the script (an example described below) according to a number of operations (discussed below) to produce a custom TLV database entry, which is then stored into the TLV configuration database 422. FIG. 6 depicts a database table 600 that includes number of example entries for custom TLVs created using the disclosed methods and systems. As shown in FIG. 6, three separate vendor-specific custom TLV entries are provided in database table 600 that address three separate functions including identifying the port of a virtual local area network (PORT VLAN ID), identifying the name of a VLAN device (VLAN NAME), and identifying/announcing a “rogue access point” (ROGUE AP DETECTION). While not expressly stated in FIG. 6, the example OUI entries are not compliant for standardized TLVs.

Again returning to FIG. 4, using vendor-specific custom TLV entries stored within the custom TLV database 422, the message parsing device 424 can use the custom TLV database entries to recognize, parse and otherwise process any received TLV element that conforms to the custom TLV as defined by the user-provided script.

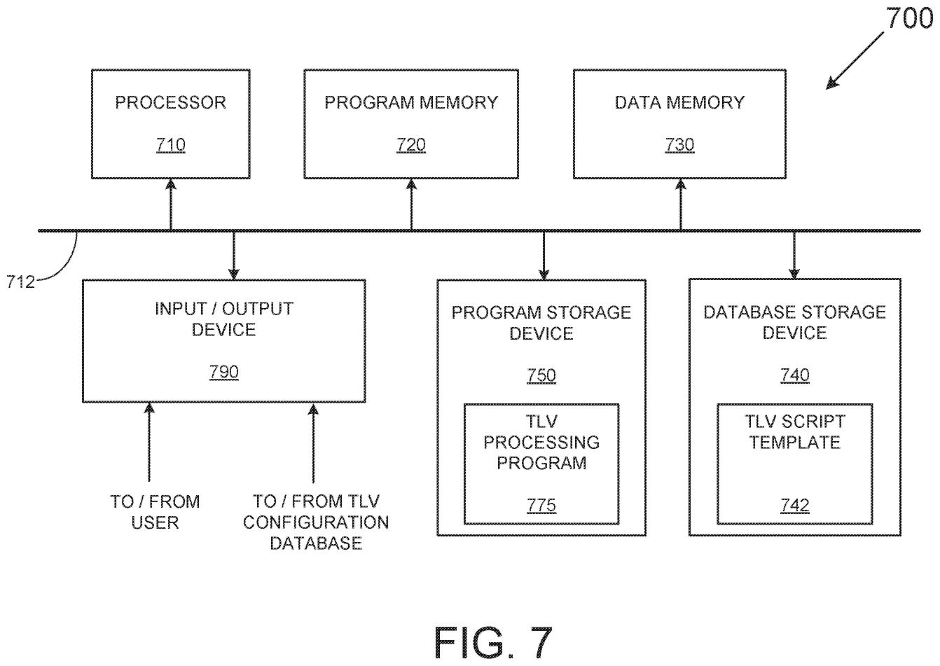

FIG. 7 is a block diagram of an example TLV configuration management device 700 usable to quickly create and process custom TLVs to produce custom TLV database entries. As shown in FIG. 7, the example TLV configuration management device 700 includes a processor 710 (e.g., a Central Processing Unit (CPU)), a program memory 720, a data memory 730, a database storage device 740, a program storage device 750, and an input/output device 790. The above components 710-790 are communicatively coupled together by a control/data bus 712.

Although the example TLV configuration management device 700 of FIG. 7 uses a bussed architecture (i.e., an architecture that relies on a control/data bus to transfer data and execute commands), it should be appreciated that any other architecture may be used as is well. For example, in various examples, the various components 710-790 can take the form of separate electronic components coupled together via a series of separate busses.

Still further, in other examples, one or more of the various components 710-790 can take form of separate servers coupled together via one or more networks, Additionally, it should be appreciated that each of components 710-790 advantageously can be realized using multiple computing devices employed in a cooperative fashion. For example, by employing two or more separate computing devices, e.g., servers, to provide separate processing and data-handling needs, processing bottlenecks can be reduced/eliminated.

It also should be appreciated that some processing, typically implemented in software/firmware routines residing in program memory 720, alternatively may be implemented using dedicated processing logic. Still further, some processing may be performed by software/firmware processes residing in separate memories in separate servers/computers being executed by different controllers.

In operation, the example TLV configuration management device 700 can first perform a number of setup operations including transferring an operating system and a number of appropriate program(s) (such as the TLV processing program 752 shown in FIG. 7) from the program storage device 750 to the program memory 720. Thereafter, the processor 710 can perform any number of processes based on user commands entered via the input/output device 790, which provides an interface with external devices (e.g., a network switch) as well as with user peripherals, such as displays and keyboards. For example, using the TLV script template 742 within the database storage device 740, a user can enter a custom TLV script suitable to be processed into a custom TLV database entry. The custom TLV database entry in turn may be stored in a TLV configuration database using the input/output device 790.

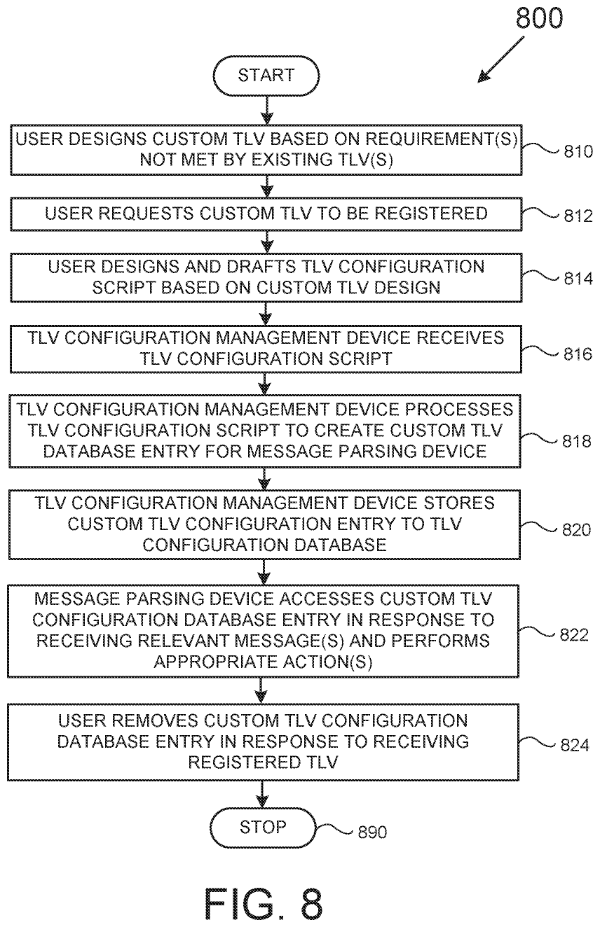

Subsequent/additional operations of the TLV configuration management device 700 are discussed below with respect to FIG. 8.

FIG. 8 is a flowchart of a method 800 usable to quickly create and deploy custom TLVs. It is to be appreciated to those skilled in the art in light of this disclosure that, while the various operations of FIG. 8 are shown according to a particular order for ease of explanation, that certain operations may be performed in different orders or performed in a parallel fashion. It is to be further appreciated that certain operations may be omitted. For instance, in certain examples the operations of 812, 814, and 824 relating to registered TLVs may be omitted.

The method 800 starts in operation 810 where a user designs a new, custom TLV based on a set of one or more requirements not met by any existing TLV. As is discussed above, when designing a TLV one should address the three fields including the “Type” field, the “Length” field, and the “Value” field in a manner that satisfies the particular functionality desired by a new TLV. As is discussed above with respect to FIG. 1, various TLV custom “type” attributes may refer to an OUI/VENDOR_ID attribute, a MAX_OCURANCES attribute, an ON_REPEAT_ACTION attribute, and a FIELD(S) attribute. Similarly, as is discussed above with respect to FIG. 2, various custom “field” attributes may refer to a VENDOR_TYPE, a FIELD_NAME, a FIELD_LENGTH, a VALUE_TYPE, a VALUE_LENGTH_KEY, and an ACTION. One or more of such attributes may, for example, be used to create a TLV that distributes information within a network to address a switch that is not authorized to use the network. The information of such a custom TLV might include the appropriate fields (e.g., a MAC address of the unauthorized switch at issue) to describe the rogue switch.

In operation 812, the user may optionally request that the new, custom TLV be registered, either according to a vendor-neutral registry or according to a vendor-specific registry so as to create external support for the new TLV.

In operation 814, the user may design and draft an appropriate TLV configuration script using any number of languages and/or any number of script templates. As is discussed above, any number of data serialization languages may provide an advantage over languages that do not support data serialization. In the example method 800 of FIG. 8, the example script includes a plurality of commands that together define a number of properties of a TLV, such as the “type” of the custom TLV and a structure of the custom TLV. As is also discussed above, the particular information used to define the different attributes in a number of non-limiting examples is shown in FIGS. 1 and 2, and an example non-limiting script is provided in FIGS. 5A-5C.

In operation 816 a processing system, such as the example TLV configuration management device 700 of FIG. 7, receives the custom TLV script of operation 816 from the user. Next, in operation 818 the processing system processes the received script to create a custom TLV configuration database entry using the plurality of commands within the script, which enables the production of a custom TLV configuration database entry that is appropriately structured so as to enable a message parsing device to identify received TLV elements that conform with the custom TLV designed in operation 810 and scripted in operation 814. An example of custom TLV configuration database entries is discussed above with respect to FIG. 6, which may be the result of one or more scripts being used to generate three separate vendor-specific custom TLV entries that address three separate functions including identifying the port of a virtual local area network (PORT VLAN ID), identifying the name of a VLAN device (VLAN NAME), and identifying/announcing a “rogue access point” (ROGUE AP DETECTION),

In operation 820, the custom TLV configuration database entry produced in operation 818 is stored in a database, such as the TLV configuration database 422 shown in FIG. 4. Accordingly, a message parsing device, such as the message parsing device 424 of FIG. 4, accessing the database is enabled to recognize, parse and otherwise process any received TLV that conforms with the custom TLV as defined by the user-provided script.

In operation 822, a message parsing device accessing the database of operation 820 uses the custom TLV configuration database entry in response to receiving an appropriately-configured TLV that conforms with the custom TLV so as to recognize, parse, and perform the appropriate actions as defined by the TLV script developed in operations 814-816.

In operation 824, the user may opt to remove the custom TLV configuration database entry in response to receiving a standardized/registered TLV, which may be provided in, for example, an update to the operating system of a communication device/system. The example method 800 then stops at operation 890.

In various examples the above-described systems and/or methods may be implemented using any form of known or later-developed circuitry (e.g., electronic, optical) or programmable device, such as a computer-based system or programmable logic. It should be appreciated that the above-described systems and methods can be implemented using any of various known or later developed programming/scripting languages, such as “YAML,” “JSON,” “Perl,” “Object Pascal,” “Pascal” “SQL,” “C,” “C++,” “FORTRAN,” “Python,” “VHDL” and the like.

Accordingly, various storage media, such as magnetic computer disks, optical disks, electronic memories or any other form of non-transient computer-readable storage memory, can be prepared that can contain information and instructions that can direct a device, such as a computer, to implement the above-described systems and/or methods. Such storage devices can be referred to as “computer program products” for practical purposes. Once an appropriate device has access to the information and programs contained on the storage media/computer program product, the storage media can provide the information and programs to the device, thus enabling the device to perform the above-described systems and/or methods. Unless otherwise expressly stated, “storage medium” is not an electromagnetic wave per se.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods related to database-related services.

While the methods and systems above are described in conjunction with specific examples, it is evident that many alternatives, modifications, and variations will be apparent to those skilled in the art. Accordingly, the examples above as set forth herein are intended to be illustrative, not limiting. There are changes that may be made without departing from the scope of the present disclosure.

What is claimed is:

1. A method comprising:
receiving an information from a user, the information including a plurality of commands that together define both a type of the custom TLV and a structure of the custom TLV;
creating a custom TLV configuration database entry using the plurality of commands, the custom TLV configuration database entry having a structure so as to enable a message parsing device of the communication system to identify received TLV elements that conform with the custom TLV, the structure including at least an organizationally unique identifier having a format not applicable to standard TLVs to enable the message parsing device to recognize the custom TLV and perform at least one desired action; and
store the custom TLV configuration database entry into a TLV configuration database accessible by the message parsing device.

2. The method of claim 1, further comprising removing the custom TLV configuration database entry from the TLV configuration database in response to receiving a registered TLV having an identical function of the custom TLV.

3. The method of claim 2, further comprising requesting a registration of the custom TLV to produce the registered TLV.

4. The method of claim 1, wherein the plurality of commands of the received information also define the at least one desired action that the message parsing device performs in response to receiving a message containing a TLV element that conforms with the custom TLV.

5. The method of claim 4, wherein the processing operation, based on the plurality of commands of the received information, structures the custom TLV configuration database entry so as to enable the message parsing device to perform the at least one desired action for any TLV element in a received message that conforms with the custom TLV.

6. The method of claim 4, wherein:
the processing operation includes the organizationally unique identifier in the custom TLV configuration database entry.

7. The method of claim 4, wherein:
the received information includes:
a unique name for an organization using the custom TLV;
a definition of an attribute of the custom TLV that the message parsing device is to detect and perform a desired action for; and
a list of one or more fields that are part of the custom TLV; and
the processing operation configures the custom TLV configuration database entry to include data that reflects the unique name, the attribute definition, and the list of one or more fields.

8. The method of claim 4, wherein the processing operation enters a default predefined setting in the custom TLV configuration database entry for a first attribute in the absence of a command in the received information that defines the first attribute.

9. The method of claim 8, wherein the default predefined setting for the custom TLV configuration database entry refers to one of a maximum number of times a TLV appears in a Protocol Data Unit (PDU) and an action to take when a same TLV appears more than once in a PDU.

10. The method of claim 1, wherein the information includes a command that defines at least one non-standard TLV attribute that the processing operation inserts in the custom TLV configuration database entry to enable the message parsing device to recognize the custom TLV and perform at least one action upon the custom TLV.

11. A non-transitory computer-readable medium comprising computer executable instructions stored thereon that when executed by a processor, cause the processor to:
receive an information from a user, the information including a plurality of commands that together define both a type of a custom TLV (Type-Length-Value) and a structure of the custom TLV;
perform a processing operation on the received information to create a custom TLV configuration database entry using the plurality of commands, the custom TLV configuration database entry having a structure so as to enable a message parsing device of the communication system to identify received TLV elements that conform with the custom TLV, the structure including at least an organizationally unique identifier having a format not applicable to standard TLVs to enable the message parsing device to recognize the custom TLV and perform at least one desired action; and
store the custom TLV configuration database entry into a TLV configuration database accessible by the message parsing device.

12. The non-transitory computer-readable medium of claim 11, wherein:
the plurality of commands of the received information also define the at least one desired action that the message parsing device performs upon receiving a message containing a TLV element that conforms with the custom TLV.

13. The non-transitory computer-readable medium of claim 12, wherein the processing operation, based on the plurality of commands of the received information, structures the custom TLV configuration database entry so as to enable the message parsing device to perform the at least one desired action for any TLV element in a received message that conforms with the custom TLV.

14. The non-transitory computer-readable medium of claim 11, wherein:
the received information includes: (1) a unique name for an organization using the custom TLV, (2) a definition of an attribute of the custom TLV that the message parsing device is to detect and perform a desired action for, and (3) a list of one or more fields that are part of the custom TLV; and
the processing operation structures the custom TLV configuration database entry to include data that represents the unique name, the attribute definition, and the list of one or more fields.

15. The non-transitory computer-readable medium of claim 11, wherein:
the received information includes a command that defines at least one non-standard TLV attribute for registered TLVs; and
the processing operation inserts the at least one non-standard TLV attribute into the custom TLV configuration database entry.

16. A processing device that enables a communication system to receive messages that include TLV (Type-Length-Value) elements by modifying the communication system to recognize and respond to a custom TLV element, the processing device comprising:
a processor and a memory communicatively coupled to the processor, the memory containing instructions that when accessed by the processor causes the processor to
receive an information from a user, the information including a plurality of commands that together define both a type of the custom TLV and a structure of the custom TLV the defined structure including at least an organizationally unique identifier having a format not applicable to standard TLVs;
perform a processing operation on the received information to create a custom TLV configuration database entry using the plurality of commands, the TLV configuration database entry being structured so as to enable a message parsing device of the communication system to identify received TLV elements that conform with the defined structure of the custom TLV, the processing operation including inserting the organizationally unique identifier into the custom TLV configuration database entry to enable the message parsing device to recognize the custom TLV and perform at least one action; and
store the TLV configuration database entry into a TLV configuration database accessible by the message parsing device.

17. The processing device of claim 16, wherein:
the plurality of commands of the received information also define the at least one desired action that the message parsing device performs upon receiving a message containing a TLV element that conforms with the custom TLV.

18. The processing device of claim 17, wherein the processor, based on the plurality of commands of the received information, structures the custom TLV configuration database entry so as to enable the message parsing device to perform the at least one desired action for any TLV element in a received message that conforms with the custom TLV.

19. The processing device of claim 16, wherein:
the received information includes: (1) a unique name for an organization using the custom TLV, (2) a definition of an attribute of the custom TLV that the message parsing device is to detect and perform a desired action for, and (3) a list of one or more fields that are part of the custom TLV; and
the processor causes the custom TLV configuration database entry to include data that reflects the unique name, the attribute definition, and the list of one or more fields.

20. The processing device of claim 16, wherein:
the received information includes a command that defines at least one non-standard TLV attribute for registered TLVs; and
the processor inserts the at least one non-standard TLV attribute into the custom TLV configuration database entry.
